(19) United States
(12) Patent Application Publication
(10) Pub. No.: US 2015/0321360 A1
(43) Pub. Date: Nov. 12, 2015

(54) MANIPULATOR FOR AN ULTRA-HIGH-VACUUM CHAMBER

(71) Applicant: AVS ADDED VALUE INDUSTRIAL ENGINEERING SOLUTIONS, S.L., Elgoibar (Gipuzkoa) (ES)

(72) Inventors: Julio Galipienzo Huguet, Elgoibar (Gipuzkoa) (ES); Miguel Ángel Carrera Astigarraga, Elgoibar (Gipuzkoa) (ES)

(21) Appl. No.: 14/433,117

(22) PCT Filed: Oct. 2, 2012
(86) PCT No.: PCT/ES2012/070680

§ 371 Date: Jul. 28, 2015

(51) Int. Cl. B25J 17/02

(52) U.S. Cl. CPC B25J 17/0216

(57) ABSTRACT

Manipulator for an ultra-high vacuum chamber comprising an annular proximal base (1a) that can be securely anchored around an access opening (2a) of a tank (2) of the ultra-high vacuum chamber, a distal base (1b) connected to the proximal base (1a) by means of a bellows element (3) with an inner space (3a) in communication with the ultra-high vacuum chamber through an access opening (2a), a sample-carrying column (4) attached to the distal base (1b), that passes through the inner space (3a) to enter into the ultra-high-vacuum chamber, and a movement system for moving the distal base (1b) in relation to the proximal base, wherein the movement system comprises six actuators (5) each one actuated by respective electric motors (6) radially arranged around the bellows element (3) and connected to the proximal base (1a) in an articulated manner by means of respective proximal ball joints (7) and connected to the distal base (1b) in an articulated manner by means of respective distal ball joints (8), and the bellows element (3) comprises a bellows comprising convolutions.

### TECHNICAL FIELD

The present invention pertains to the technical field of manipulators useful for positioning objects in ultra-high vacuum chambers.

### BACKGROUND OF THE INVENTION

The ultra-high vacuum manipulator has applications such as in material tests, as well as in cyclotrons and synchrotrons. Ultra-high vacuum (UHV) means vacuums with a pressure lower than 10⁻⁷ mbar. Ultra-high vacuum is obtained in UHV chambers provided with devices that allow gases and humidity to evacuate from the inner chamber, such as extraction pumps and heaters that allow heating and baking the inside of the system at temperatures of between 100 and 400° C. during evacuation. It is extremely important to build all the parts of the UHV chamber with materials that are resistant to the extremely low pressures and very high temperatures during baking, and moreover such materials must not release gases during the evacuation and baking processes, or during the use of the UHV chamber. To prevent gases from being released during the use of the UHV chamber, the tank walls may be cooled by using liquid nitrogen.

In order to arrange objects inside the UHV chamber, manipulators that include a sample carrier are used. For some applications, the objects must be arranged on variable positions, in which case the manipulator comprises a movement system, which is actuated manually and/or by means of one or more motors and which is capable of positioning the sample carrier in the desired positions. To achieve this positioning, the movement system may be a mechanical coupling that is resistant to the UHV pressure through the tank wall, and able to confer rotational or linear movements, or combinations of the same. The parts of the manipulator that are in direct contact with the inside of the tank must conveniently fulfil the same requirements with regard to resistance to the baking temperature, UHV pressure and release of gases as the UHV chamber itself. Moreover, the other parts must also conveniently be capable of resisting relatively high temperatures (approximately 80° C.), which are transmitted from the UHV chamber during baking.

U.S. Pat. No. 6,019,008A which comprises an annular proximal base that can be securely anchored externally around an access opening of a tank comprising the ultra-high vacuum chamber, a distal base connected to the proximal base by means of a bellows element with an inner space communicated with the ultra-high vacuum chamber through the access opening, and a sample-carrying column attached to the distal base and that passes through said inner space of the bellows element and dimensioned to extend through the proximal base and the access opening of the ultra-high vacuum chamber, wherein the sample carrier may be axially moved inside the bellows. The telescopic structure is exposed to the vacuum and baking conditions of the UHV chamber.

Patent application EP0191648A2 describes a manipulator for UHV chambers of the aforementioned type in which the sample-carrying column may be axially moved and rotated inside the bellows.

Patent application EP0983826A2 describes a manipulator for UHV chambers of the aforementioned type, wherein the movement system allows providing the sample carrier with rotational, axial and tilting movements. Part of the tilting mechanism is located close to the sample carrier, that is, therefore it is exposed to the vacuum and baking conditions of the UHV chamber.

The manipulators of the state of the art essentially only allow the sample carrier to move with very few degrees of freedom and, in the case of the patent application EP0983826A2, which allows the sample carrier to be tilted, they carry moving elements directly or indirectly exposed to the vacuum and baking conditions of the UHV chamber, which further entails difficulties in precisely controlling the position of the sample carrier.

### DESCRIPTION OF THE INVENTION

The object of the present invention is to overcome the drawbacks of the state of the art by means of a manipulator for an ultra-high vacuum chamber comprising an annular proximal base that can be securely anchored externally around an access opening of a tank of the ultra-high vacuum chamber, a distal base connected to the proximal base by means of a bellows element with an inner space in communication with the ultra-high vacuum through the access opening, a sample-carrying column attached to the distal base and that passes through said inner space of the bellows element and dimensioned to extend through the proximal base and said access opening to the ultra-high vacuum chamber, as well as a movement system for moving the distal base in relation to the proximal base, wherein

the movement system comprises six actuators actuated by respective electric motors radially arranged around the bellows element and connected to the proximal base in an articulated manner by means of respective proximal ball joints and connected to the distal base in an articulated manner by means of respective distal ball joints;

the bellows element comprises a vacuum bellows comprising convolutions.

These features of the manipulator allow the sample-carrying column to be moved efficiently and, therefore, the sample carrier, with five degrees of freedom, in a simple and stable manner and without needing to arrange moving elements inside the ultra-high vacuum (UHV) chamber, by means of the movement of the positions of each actuator between its retracted position and its extended position, which provides complete versatility regarding the positioning of the object inside the ultra-high vacuum chamber.

The term ‘comprises’ and its variations (such as ‘comprising’, etc.) should not be construed in an exclusive sense, i.e. these do not exclude the possibility of the inclusion of other elements, steps, etc. in that which is described. On the other hand, in the context of the present invention, the terms ‘proximal’ and ‘proximally’ are used in this description and in the appended claims to define positions or parts of elements closest to the ultra-high vacuum chamber, whilst the terms ‘distal’ and ‘distally’ are used in this description and the appended claims to define positions or parts of elements furthest from the ultra-high vacuum chamber.

Preferably, the proximal ball joints are radially arranged in outer radial points than the distal ball joints. Also preferably, the movement system may comprise three pairs of actuators arranged around the bellows element. The actuators of each pair of actuators are connected to the proximal base in an articulated manner by a pair of proximal ball joints separated from each other by a first angular distance and to the distal base by a pair of distal ball joints separated from each other by a second angular distance, which is greater than said first angular distance.

The pairs of distal ball joints and/or the proximal ball joints may be angularly equidistant from each other, and the actuators of each pair of actuators may be coupled to each other by an anti-rotation connecting rod that prevents the actuators from rotating around the axial shaft thereof.

Each proximal ball joint may comprise a proximal spherical bearing arranged on the proximal base and a proximal spherical head element mounted on one of the actuators. In turn, each distal ball joint may comprise a distal spherical bearing arranged on the distal base and a distal spherical head element mounted on this actuator. This type of ball joint is ideal for guaranteeing a better repeatability of movements, as well as guaranteeing rigidity and facilitating the programming of the software, since the pivot point is known and the same for all the rotations.

The distal base may comprise an outer periphery with three flanges radially protruding and angularly equidistant from each other, in such a way that the actuators of each pair of actuators may be connected in an articulated manner to one of the three flanges by means of a pair of distal ball joints.

The manipulator may be provided with an annular adaptor flange, which is anchored to the annular proximal base and may be anchored around the access opening of the tank. The use of this flange avoids the need to make additional fastening holes in the tank, and allows the mechanical interface of the hexapod to be adapted to each application, thus providing it with greater versatility. Furthermore, the manipulator may be mounted on different tank models by means of specific adaptor flanges.

The bellows element is designed to resist the ultra-high vacuum conditions present in the ultra-high vacuum chamber without leaks and without risk of implosion, and in addition, it must resist the heat conditions of baking. The number of convolutions of the bellows element shall depend on the range of motion of the distal base with regard to the proximal base of the manipulator.

The bellows element may comprise a proximal annular base connected to the proximal base and a distal annular flange connected to the distal base. Preferably, the proximal annular flange has a proximal diameter greater than the distal annular flange. The bellows element may further comprise a proximal part connected to the proximal annular flange and a distal part connected to the distal annular flange. The proximal part, the distal part and the bellows element are connected to one another by means of a dividing ring.

In an especially preferred embodiment, this dividing ring comprises a proximal annular section connected to the proximal part of the bellows element and a distal annular section connected to the distal part of the bellows element. The proximal annular section has a greater diameter than the distal annular section. Alternatively or complementarily, the bellows element may be at least partially frustoconical. According to this especially preferred embodiment, the periphery of the distal base may have a smaller diameter than the annular proximal base, which allows housing the distal ball joints in the smallest diameter possible, which allows the space needed to arrange the manipulator to be reduced and, if applicable, prevent interferences and collisions with the other elements, such as the cryomanipulator, which is in the same part of the tank, such as the top plate of the tank for example. The fact that the bellows element has a proximal section with a greater diameter than the distal section enables greater tilting angles, i.e. a more varied manoeuvring capacity of the manipulator, to be achieved. When present, the emerging wings allow the space needed to arrange the manipulator to be reduced even more.

With the object of preventing, in view of the ultra-high vacuum in the inner space of the bellows element, the atmospheric pressure of the surroundings from pushing the dividing ring towards the proximal flange of the bellows due to the change in cross-section from the upper to the lower section, several springs, such as three springs for example, may be mounted preferably angularly and equidistant to each other, and which join the proximal flange with the dividing ring. These springs are designed to ensure a minimum separation between the dividing ring and the proximal flange of the bellows element. In this way, the dividing ring is prevented from coming too close to the proximal flange, and from moving the proximal and distal sections of the bellows element outside the maximum and minimum range of operation.

In a preferred embodiment, the distal base of the manipulator comprises a central opening and the sample-carrying column is connected to a clamping plate mounted on the distal base to seal said central opening.

In accordance with the invention, each actuator preferably comprises an electric motor with a drive shaft connected to a reduction gear, a ball screw coupled proximally to the reduction gear, and a distal fixed nut on which the ball screw rotates, a hollow, outer moving body and a hollow, inner fixed body. Appropriate electrical motors may be, for example, those marketed by the group of companies FAULHABER with the name FAULHABER STEPPER AM1020.

The hollow, outer moving body has an inner axial passage in which the nut of the ball screw is immobilized, which may be of the EICHENBERGER brand, a distal end on which the distal spherical head element is mounted and an open proximal end. The outer moving body may comprise an insert piece screwed into the distal end of the outer moving body.

The outer moving body is axially slidable over the inner moving body on longitudinal guide rails, which may be of the brand IKO, between an extended position and a retracted position by action of the ball screw that, when it rotates, it moves the fixed nut that pulls the outer moving body.

The guide rails may be provided with at least two opposite outer faces of the inner fixed body. These guide rails guide runners that are in contact with the inner faces of the inner axial passage of the outer moving body, which are facing the outer faces of the inner fixed body. This rail and runner system enables the outer moving body to move in relation to the inner fixed body.

In one embodiment of the invention, in each guide rail there is a pair of preloaded recirculating ball screw runners, with a U-shaped transversal cross-section that surround the top and sides of the rail. The runners are arranged one after another in the axial direction and separated axially from each other by a predetermined distance based on the path of the outer moving body between its retracted position and its extended position. The pairs of runners are immobilized in respective axial recesses provided in the opposite inner faces of the outer moving body.

With the purpose of aligning and guaranteeing the position of the guide rails, each one of them may be arranged on the corresponding outer face of the inner fixed body with the longitudinal sides thereof tightened between an axial step made in said outer face and an immobilisation wedge that is screwed into a complementary axial slot that extends along the length of the corresponding guide rail. Thus, it is guaranteed that the guide rail is always in contact with the axial step, and that at no point during the screwing phase does the guide rail become detached from said step.

On the other hand, in order to align and guarantee the position of the outer moving body in relation to the inner fixed body, a tightening system may be provided that holds the respective longitudinal sides of the runners of one of the pairs of runners between a side reference face of the axial recess of the outer moving body and a plurality of studs threaded in through-holes, which are aligned parallel to the sides of the runners, and the tightening of which on the respective sides of the corresponding runners pushes the opposite sides towards the reference face of the axial recess of the outer moving body. In order to prevent overrestrictions, the pair of runners provided in the axial recess of the opposite side of the outer moving body is not provided with such a tightening system, such that the sides of the runners of this other pair of runners are arranged on said opposite axial recess with a certain lateral looseness.

The hollow, inner fixed body is at least partially inserted into the inner axial passage of the outer moving body, and comprises a proximal end on which said proximal spherical head is mounted, a distal end facing the fixed nut, and an axial cavity that extends between the proximal end and the distal end of the hollow inner body, and on which the electric motor and the reduction gear are mounted.

The ball screw may comprise a connection shaft coupled, by means of a flexible coupling that may be of the brand R+W, to an output shaft of the reduction gear and guided in at least one bearing element selected from angular bearings and radial ball bearings, arranged on the axial cavity of the inner fixed body. The bearing element may comprise a packet of preloaded angular bearings comprising a sleeve in which two bearing brackets for compressive stress and one bearing bracket for tensile stress are housed.

The connection shaft of the ball screw and the output shaft of the reduction gear may have respective flat faces and are coupled to each other by means of a flexible coupling comprising a stud aligned with said flat faces. In order to align the flat faces of the output shaft of the reduction gear with the stud, the drive shaft of the electric motor comprises a proximal axial extension on which a gear is mounted that enables the drive shaft to rotate. In this way, the shaft is prevented from rotating in the opposite direction, i.e., by applying torque from the output of the reduction gear to the motor, which could damage the reduction gear.

In accordance with the invention, each actuator may be linked to a sensing device to detect positions of the actuator between said extended position and said retracted position. The sensing device is an absolute optical encoder mounted on a notch on a wall of the outer moving body facing a longitudinal ruler fixed to an outer face of the inner fixed body. Suitable encoders and rulers may be, for example, those marketed by the group of companies RENISHAW with the designations RL26BAT050B50F RESOLUTE, BISS LINEAL 26B, 1VPP (encoder) and A-9763-0005 (stainless steel ruler), respectively.

The control of these elements can be made, for example, by a UMAC Turbo Controller 3U, 32 controller card with axis controller with 100 Mbit Ethernet card and USB2.0, 2 ACC-24E2S cards for the connection of stepper motor controllers, an ACC-R2 12-slot rack, 2 ACC-84e cards for the connection of Biss-C encoders and the software ACC-9WPR02 marketed by the company DELTA TAU.

### BRIEF DESCRIPTION OF THE DRAWINGS

In order to complement the description and with the object of helping to a better understanding of the features of the invention, according to a preferred example of practical embodiment of the same, a set of drawings is attached as an integral part of the description, wherein by way of illustration and without limitation, the following has been represented:

FIG. 1 is a top perspective view of an embodiment of the manipulator according to the present invention in its resting position and arranged on a tank of an ultra-high vacuum chamber.

FIG. 2 is a perspective view of the manipulator shown in FIG. 1.

FIG. 3 is a sectional perspective view of the manipulator shown in FIGS. 1 and 2.

FIG. 4 is a sectional perspective view of the manipulator shown in FIGS. 1 and 2 in a displaced position.

FIG. 5 is a top perspective view of an embodiment of the adaptor flange of the manipulator shown in FIG. 3.

FIG. 6A is a perspective view of the bellows element shown in FIGS. 1 to 4.

FIG. 6B is a perspective view of an alternative embodiment of the bellows element that can be applied to the manipulator shown in FIGS. 1 to 4.

FIG. 7 is a schematic view of an embodiment of the basic features of an actuator for a manipulator according to the invention.

FIG. 8 is a sectional side view of the detailed model of the actuator shown comprising the basic features of the actuator shown in FIG. 7.

FIG. 9 is a sectional side view of the actuator, along a plane perpendicular to the section used in FIG. 8.

FIG. 10 is a view of the detail A marked in FIG. 9.

FIG. 11 is a cross section view along the line I-I of the actuator shown in FIG. 8.

FIG. 12 is a sectional distal perspective view of the actuator shown in FIG. 8.

These figures have numerical references identifying the following elements
1 manipulator
1a proximal base
1b distal base
1c wings
1d through-hole
1e centring drill
1f central opening
2 tank
2a access opening
2b top plate of tank
2c cap
3 bellows element
3a inner space
3b proximal annular flange
3c distal annular flange
3d proximal part
3e distal part
4 sample-carrying column
4a clamping plate
5 actuators
6 electric motor
6a drive shaft
6b proximal axial extension
7 proximal ball joint
7a proximal spherical bearing
7b proximal spherical head element
7c threaded shaft
8 distal ball joint
8a distal spherical bearing
8b distal spherical head element
8c threaded shaft
9 anti-rotation connecting rod
9a axial slot
9b coupling pin
10 annular adaptor flange
10a threaded blind hole
10b through holes
10c first centring holes
10d second centring holes
11 dividing ring
11a proximal annular section
11b distal annular section
11e spring
11d connector arm
11e connecting block
12 reduction gear
12a output shaft
13 ball screw
13a connection shaft
13b rotatable bushing
14 distal fixed nut
15 outer moving body
15a inner axial passage
15b distal end
15c open proximal end
15d guide axial recess
15e reference side wall
16 inner fixed body
16a proximal end
16b a distal end
16c axial cavity
16d axial step
16e guide axial channel
16f proximal insert
16g complementary axial slot
17 guide rails
17a immobilization wedge
18 annular bearing element
18a bearing bracket for compressive stress
18b bearing bracket for tensile stress
18c sleeve
18d proximal nut
18e distal nut
19 coupling
20 sensing device
21 longitudinal ruler
22 distal insert
23 runner
23a side of the runner
23b stud
24 pinion
25 cryomanipulator
26 first sealing rings
27 proximal sealing ring
28 mechanical stop

### MODES FOR CARRYING OUT THE INVENTION

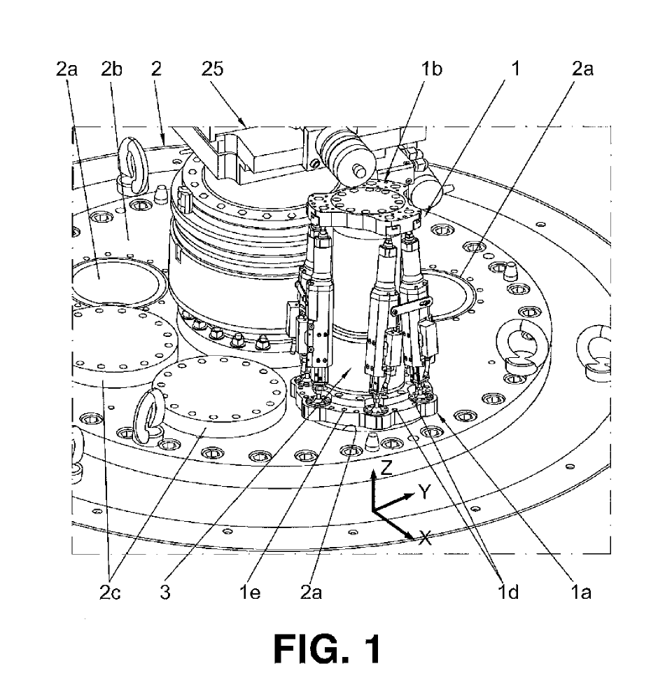

FIG. 1 shows one embodiment of the manipulator -1- for an ultra-high vacuum chamber externally mounted around one of several access openings -2a-, which may be DN100 ports, provided on a top plate -2b- of a tank -2- of the ultra-high vacuum chamber and which can be used to couple other conventional devices to the top plate. The access openings -2a- that are not used can be closed by means of caps -2c- attached on the top plate -2b- by means of screws. A cryomanipulator -25- is also provided in the centre of the top plate -2b- in a conventional manner.

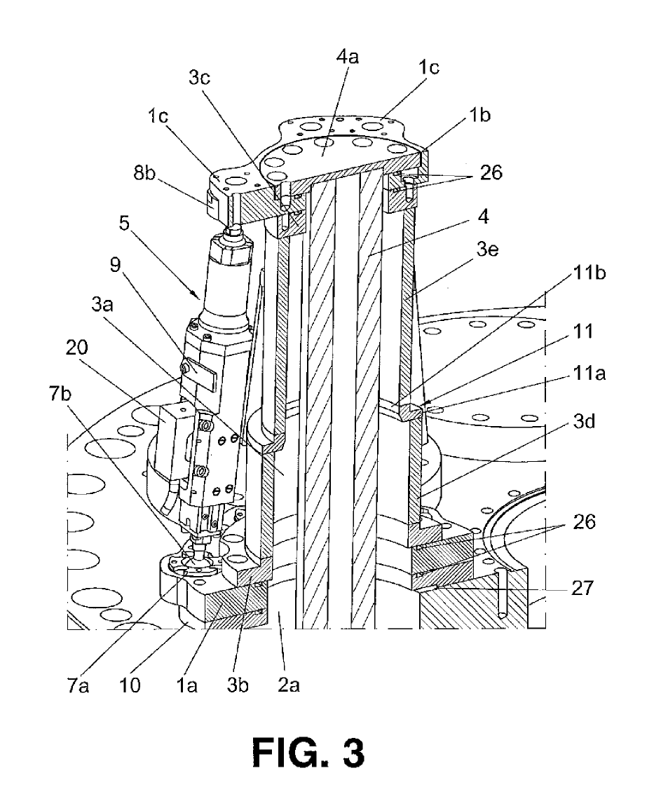

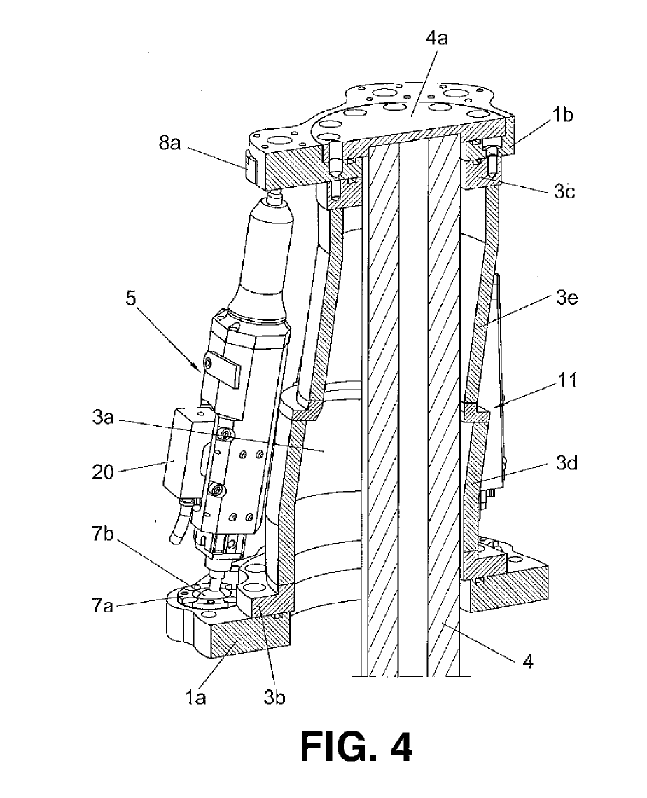

The manipulator -1- comprises an annular proximal base -1a- that can be securely anchored externally around the access opening -2a- of the top plate -15b- of the tank -2- of the ultra-high vacuum chamber, a distal base -1b-, a sample-carrying column -4- (FIGS. 3, 4), and a movement system for moving the distal base -1b- in relation to the proximal base comprising six actuators -5- each one actuated by respective electric motors -6- radially arranged around the bellows element -3- and connected to the proximal base -1a- in an articulated manner by means of respective proximal ball joints -7- and connected to the distal base -1b- in an articulated manner by means of respective distal ball joints -8-. The distal base -1b- is connected to the proximal base -1a- by means of a convolution bellows element -3- with an inner space -3a- in communication with the ultra-high vacuum chamber through the access opening -2a-. The sample-carrying column -4- is attached to the distal base -1b- and passes through said inner space -3a- of the bellows element -3- dimensioned to extend through the proximal base -1a- and said access opening -2a- to the ultra-high vacuum chamber.

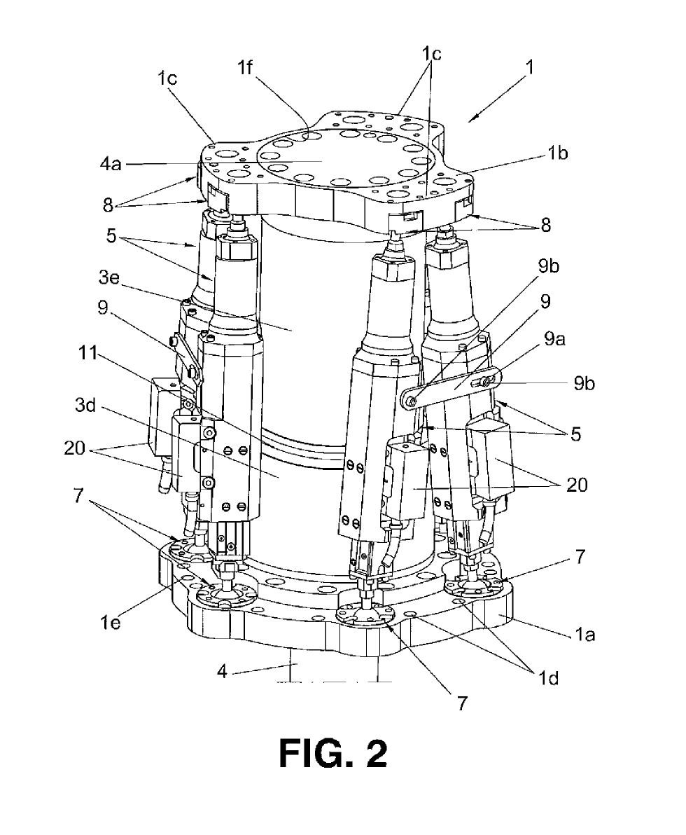

As can be seen in more detail in FIGS. 2 to 4, the proximal ball joints -7- are radially arranged in outer radial points than the distal ball joints -8-. Each proximal ball joint -7- comprises a proximal spherical bearing -7a- arranged on the proximal base -1a- and a proximal spherical head element -7b- with a threaded shaft -7c- mounted on one of the actuators -5-, and each distal ball joint -8- comprises a distal spherical bearing -8a- arranged on the distal base -1b- and a distal spherical head element -8b- with a threaded shaft -8c- mounted on the actuator -5-.

The actuators -6- are grouped into three pairs of actuators -6- arranged around the bellows element -3-. In order to prevent the actuators -5- from rotating around the axial shaft thereof, the actuators -5- of each pair of actuators -5- are coupled to each other by an anti-rotation connecting rod -9- preferably made of resiliently flexible plastic material. The anti-rotation connecting rod -9- comprises, on one end, an axial slot -9a-, and on the opposite end a coupling hole. The anti-rotation connecting rod -9- is coupled to the actuators -5- forming the pair of actuators by means of respective coupling pins -9b- emerging from the outer faces of the actuators and which respectively pass through the coupling hole and the axial slot -9a-, such that the anti-rotation connecting rod -9- can rotate in the respective coupling pins -9b- while it can slide in one of the coupling pins -9b-.

The actuators -5- of each pair of actuators -5- are connected in an articulated manner to the proximal base -1a- by a pair of proximal ball joints -7- separated from each other by a first angular distance and to the distal base -1b- by a pair of distal ball joints -8- separated from each other by a second angular distance, which is greater than said first angular distance. The pairs of distal ball joints -8- are angularly equidistant from each other, and are located respectively on one of three equidistant wings -1c- protruding radially from the outer periphery of the distal base -1b-. In turn, the pairs of proximal ball joints -7- are angularly equidistant from each other, but with separation angles between pairs of ball joints that are different and greater than those of the distal ball joints -8-. The annular proximal base -1a- of the manipulator -1- is anchored in an annular adaptor flange -10- by means of screws traversing through-holes -1d- of the annular proximal base -1a-. The annular proximal base -1a- also comprises two diagonally opposite centring drills -1e-. In turn, the distal base -1b- comprises a central opening -1f- and the sample-carrying column -4- is attached to a clamping plate -4a- mounted on an annular step surrounding the central opening -1f- to seal the central opening -1f-.

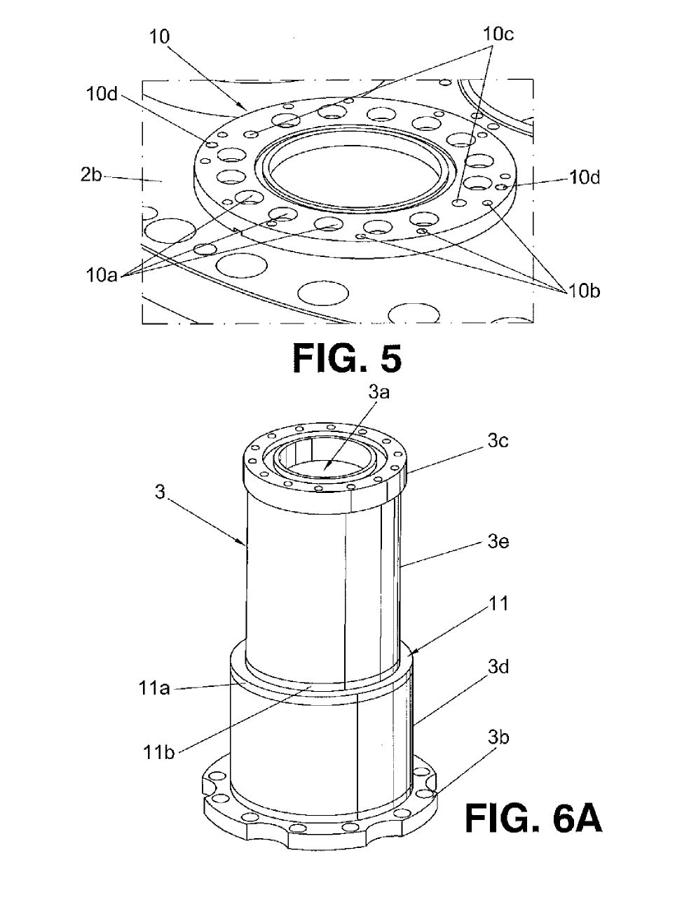

As can be seen in FIG. 5, this adaptor flange -10- comprises a plurality of radial drill holes for accommodating screw head -10a-, to fasten the annular adaptor flange -10- to the top plate -2b, of the tank; a plurality of peripheral through holes -10b- through which the proximal base -1a- is fastened to the adaptor flange -10, as well as two diagonally opposite first centring holes -10c-, used for centring the adaptor flange -10- with the top plate -2b- and two diagonally opposite second centring holes -10d-, used for centring the proximal base -1a- with the annular adaptor flange -10-.

Respective second pins are inserted in the second centring holes -10d- to mount the annular proximal base -1a- on the adaptor flange -10-. The pins are aligned with the centring drills -10e- and the annular proximal base -1a- is placed over the adaptor flange -10-. Next, and through the second through-holes -1d- of the annular proximal base -1a-, screws are inserted and screwed (not shown in the figures) in the blind threaded holes -10b- of the adaptor flange -10-, such that the annular proximal base -1a- is firmly bolted to the adaptor flange -10-.

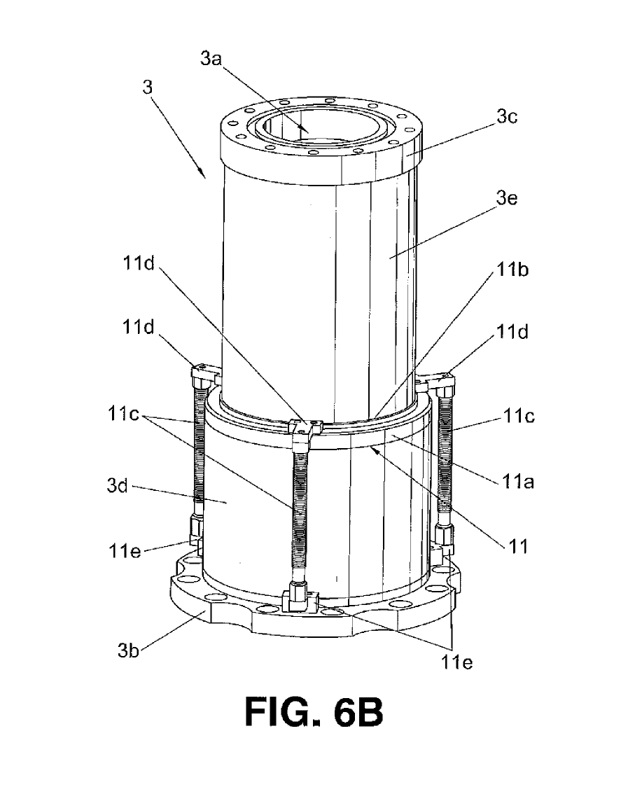

In the embodiment shown in FIGS. 1 to 4, 6A and 6B, the bellows element -3- comprises a proximal annular flange -3b- bolted to the proximal base -1a- and a distal annular flange -3c- bolted to the distal base -1b-. Specifically, the bellows element -3- comprises a cylindrical proximal part -3d- connected to the proximal annular flange -3b- and a cylindrical distal part -3e- connected to the distal annular flange -3c-. The proximal part -3d- and the distal part -3e- of the bellows element are connected to one another by means of a dividing ring -11- comprising a proximal annular section -11a- attached to the proximal part -3d- of the bellows element -3- and a distal annular section -11b- connected to the distal part -3e- of the bellows element -3-. The distal annular section -11b- has a smaller diameter than the proximal annular section -11a-. In the embodiment of the bellows element -3- shown in FIG. 6B, the dividing ring -11- and the proximal flange -3b- of the bellows element -3- are connected to one another by means of three helical springs -11c- which prevent, in view of the ultra-high-vacuum existing in the inner space -3a- of the bellows element -3-, the atmospheric pressure of the environment from pushing the dividing ring -11- towards the proximal flange -3b- of the bellows element, due to the section change from the distal to the proximal section. The springs -11c- are coupled at their distal ends to respective connector arms -11d- that emerge radially from the perimeter of the dividing ring -11- and at their proximal ends to respective connecting blocks -11e- attached to the proximal flange -3b-. The springs -11c- are designed to ensure a minimum separation between the dividing ring -11- in relation to the proximal flange -3b-, and preventing the dividing ring -11- from getting too close to the proximal flange -3b- and moving the proximal section -3d- and the distal section -3e- of the bellows element -3- outside the maximum and minimum range of operation.

First respective sealing rings are arranged in respective annular slots between the tightening plate -4a- and the annular step surrounding the central opening -1f- on the distal base -1b-, between the distal base -1b- and the distal flange -3c- of the bellows -3-, between the proximal flange -3b- and the annular proximal base -1a-, and between the annular proximal base -1a- and the adaptor flange -10-. These first sealing rings may be HELICOFLEX sealing rings marketed by TECHNETICS GROUP. In turn, a proximal sealing ring -27- of DN100 ISO CF type is arranged between the adaptor flange -10- and the top plate -2b- of the tank -2-.

As can be seen by comparing the positions shown in FIGS. 2, 3, and 4, by varying the positions of each actuator -5- between its retracted position and its extended position, the sample-carrying column and, therefore, the sample carrier (not shown in the figures), can move with five degrees of freedom, since the rotation around the vertical axis is restricted by the limitation of rotation of the bellows. The number of convolutions of the bellows element -3- will depend on the range of motion of the distal base -1b- in relation to the proximal base -1a- of the manipulator -1-.

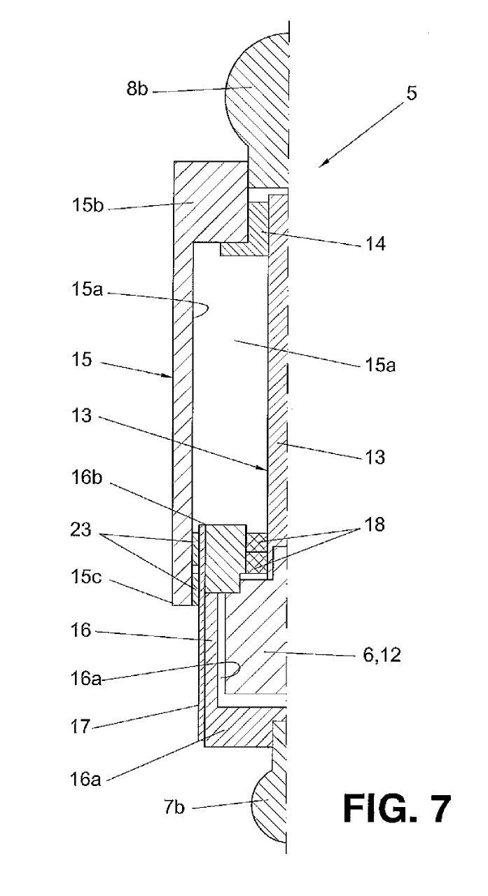

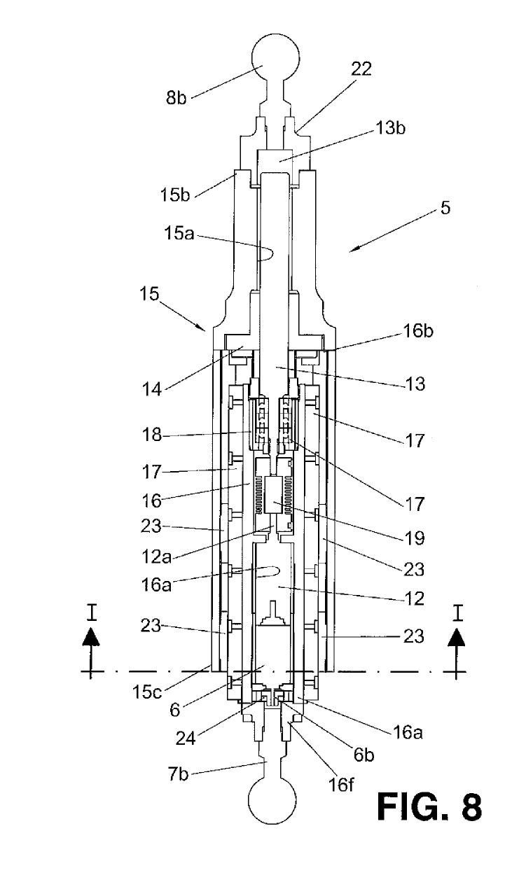

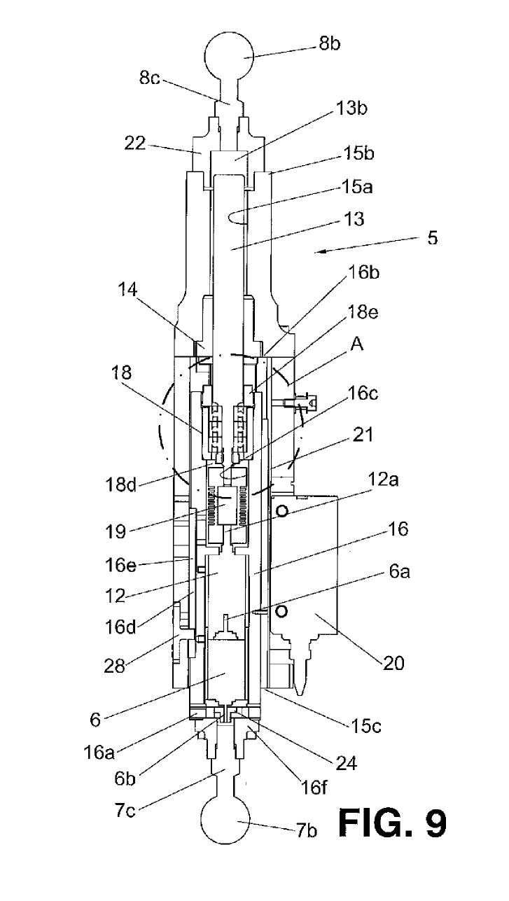

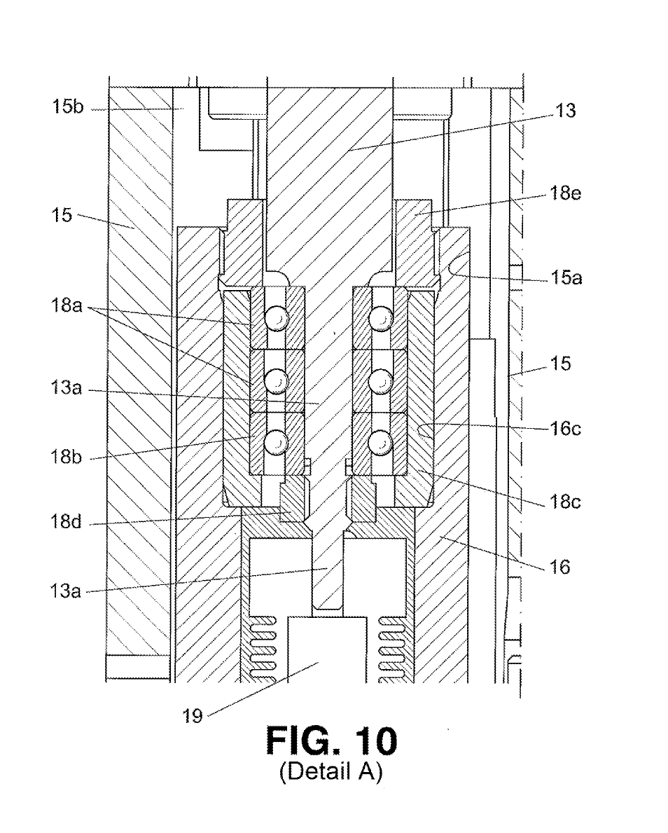

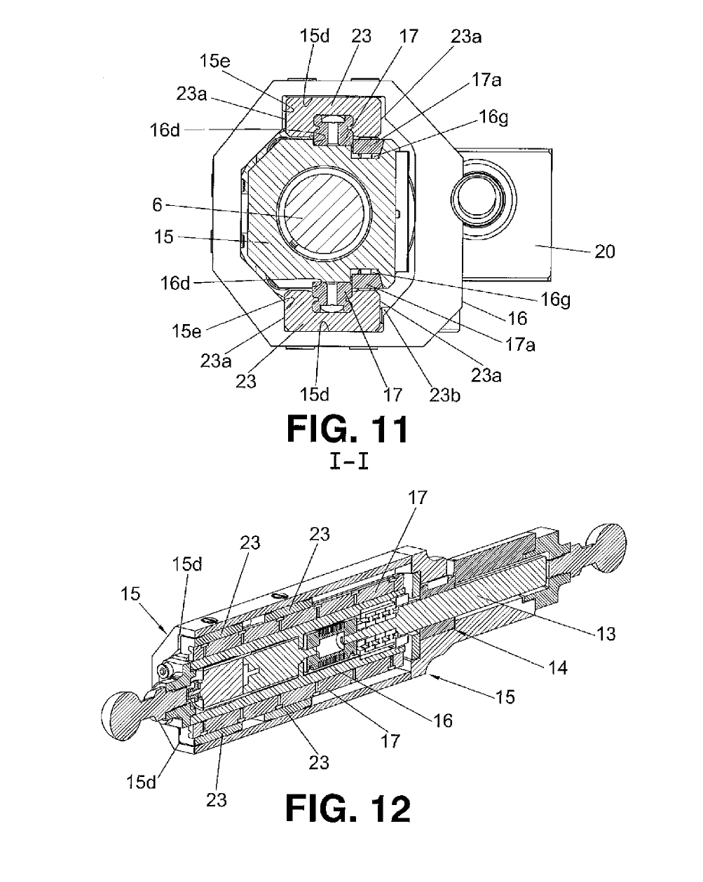

In the embodiment shown in FIGS. 7 to 10, the actuator -5- comprises an electric motor -6- with a drive shaft -6a- connected to a reduction gear -12-, a ball screw -13- coupled proximally to the reduction gear -12-, and a fixed distal nut -14- in which the ball screw -13- rotates, an outer moving body -15- and an inner fixed body -16-.

The hollow outer moving body -15- has an inner axial passage -15a- in which the fixed nut is immobilized -14-, a distal end -15b- on which the distal spherical head element -8b- is mounted and an open proximal end -15c-. The distal spherical head element -8b- is mounted on an insert -22- threaded on the distal end -15b- of the outer moving body -15- and in which, in turn, the threaded shaft -8c- of the distal spherical head element -8- is threaded.

The hollow inner fixed body -16- is at least partially inserted into the inner axial passage -15a- of the outer moving body -15-, and comprises a proximal end -16a- to which an proximal insert -16f- is fastened, bolted to the proximal end -16a- of the inner fixed body -16- and centred by adjustment diameter, in which the rod -7c- of the proximal spherical head -7b- is threaded, a distal end -16b- facing the fixed nut -14-, and an axial cavity -16c- that extends between the proximal end and the distal end of the hollow inner body, and on which the electric motor -6- and the reduction gear -12- are mounted.

The outer moving body -15- is axially slidable over the inner moving body -16- on longitudinal guide rails -17-, between an extended position and a retracted position by action of the ball screw -13- that, when it rotates, moves the fixed nut -14- that pulls the outer moving body -15-. The displacement between said positions is limited by a mechanical stop -28- fixed on the outer moving body -15- and with a protrusion that moves on a guide axial channel -16e- provided in an outer face of the inner fixed body -16- when the outer moving body moves with respect to the inner fixed body -16-. The guide axial channel -16e- has a longitudinal extension which delimits the path of the protrusion of the mechanical stop -28- and, therefore of the displacement of the outer moving body -15- with respect to the inner fixed body -16-.

The guide rails -17- are arranged on at least two opposite outer faces of the inner fixed body -16-, and guide runners -23- contacting inner faces of the inner axial passage -15a- of the outer moving body -15- facing the outer faces of the inner fixed body -16-, and are arranged on opposite side outer faces of the inner fixed body.

In each guide rail -17- a pair of preloaded recirculating ball screw runners -23- is guided, with a U-shaped transversal cross-section that surround the top and sides of the guide rail -17-. The runners -23- are arranged one after another in the axial direction and axially separated from each other by a predetermined distance based on the path of the outer moving body 15- between its retracted position and its extended position. The pairs of runners -23- are immobilized in respective axial recesses -15d- provided in the opposite inner faces of the outer moving body -15-.

With the purpose of aligning and guaranteeing the position of the guide rails -17-, each one of them may be arranged on the corresponding outer face of the inner fixed body -16- with the longitudinal sides thereof tightened between an axial step -16d- made in said outer face and an immobilisation wedge -17a- that is screwed into a complementary axial slot -16g- that extends along the length of the corresponding guide rail -17-. Thus, it is guaranteed that the guide rail -17- is always in contact with the axial step -16d-, and that at no point during the screwing phase does the guide rail -17- become detached from said step -16d-.

Likewise, in order to align and guarantee the position of the outer moving body -15- in relation to the inner fixed body -16-, a tightening system may be provided that holds the respective longitudinal sides of the runners -23a- of one of the pairs of runners -23- between a side reference face -15e- of the axial recess -15d- of the outer moving body -15- on which respective sides -23a- of one face of the runners -23- are supported, and a plurality of studs -23b- threaded in through-holes, which are aligned parallel to the respective opposite sides of the runners -23-. The tightening of these studs -23b- on the respective sides of the runners -23- pushes the other side of the runner towards the reference wall -15e- of the axial recess -15d- of the outer moving body -15-. In order to prevent over restricting, the pair of runners -23- provided in the axial recess -15d- of the opposite side of the outer moving body -15- is not provided with such a tightening system, such that the sides -23a- of the runners -23- of this other pair of runners are arranged on said opposite axial recess -15d- with a certain lateral looseness.

The ball screw -13- comprises a connection shaft -13a- coupled to an output shaft -12a- of the reduction gear -12- and guided in at least one annular bearing element -18- arranged on the axial cavity -16c- of the inner fixed body -16- and in a distal rotatable bushing -13b- mounted on the distal insert -22-. The connection shaft -13a- of the ball screw -13- and the output shaft -12a- of the reduction gear -12- have respective flat faces and are coupled to each other by means of a coupling -19- comprising a stud aligned with said flat faces. The drive shaft -6a- of the electric motor -6- comprises a proximal axial extension -6b- on which a gear is mounted -24- that allows the drive shaft to rotate -6a- to align the flat face of the output shaft -12a- of the reduction gear -12- with the stud. The packet of bearings is immobilized between a proximal nut -18d- and a distal nut -18e-.

The bearing element -18- comprises a packet of preloaded angular bearings -18a, 18b- comprising a sleeve -18c- in which two bearing brackets for compressive stress -18a- and one bearing bracket for tensile stress -18b- are housed. The sleeve protects the bearings from the studs used to immobilize the packet of bearings -18a, 18b-.

Each actuator -5- is linked to an absolute optical encoder mounted on a notch on a wall of the outer moving body facing a longitudinal ruler -21- fixed to an outer face of the inner fixed body -16- -20- to detect positions of the actuator -5- between said extended position and said retracted position.

The invention is not limited to the specific embodiments that have been described but it also includes, for example, the variants which may be carried out by the person with average skill in the art (for example, regarding the choice of materials, dimensions, components, configuration, etc.), within what can be deduced from the claims.

1. Manipulator for an ultra-high vacuum chamber comprising
an annular proximal base that can be securely anchored externally around an access opening of a tank of the ultra-high vacuum chamber,
a distal base connected to the proximal base by means of a bellows element with an inner space in communication with the ultra-high vacuum chamber through the access opening,
a sample-carrying column attached to the distal base and that passes through said inner space of the bellows element, dimensioned to extend through the proximal base and said access opening to the ultra-high vacuum chamber,
a movement system for moving the distal base in relation to the proximal base,
wherein
the movement system comprises six actuators each one actuated by respective electric motors radially arranged around the bellows element and connected to the proximal base in an articulated manner by means of respective proximal ball joints and connected to the distal base in an articulated manner by means of respective distal ball joints,
the bellows element comprises a vacuum bellows comprising convolutions.

2. Manipulator, according to claim 1, wherein the proximal ball joints are radially arranged in outer radial points than the distal ball joints.

3. Manipulator, according to claim 1 or 2, wherein
the movement system comprises three pairs of actuators arranged around the bellows element;
the actuators of each pair of actuators are connected to the proximal base in an articulated manner by a pair of proximal ball joints separated from each other by a first angular distance and to the distal base by a pair of distal ball joints separated from each other by a second angular distance, which is greater than said first angular distance.

4. (canceled)

5. Manipulator, according to claim 3, wherein the actuators of each pair of actuators are coupled to each other by an anti-rotation connecting rod.

6. (canceled)

7. Manipulator, according to claim 4, wherein
the distal base comprises an outer periphery with three wings protruding radially and angularly equidistant from each other;
the actuators of each pair of actuators are connected in an articulated manner to one of the three wings by means of a pair of distal ball joints.

8. Manipulator, according to claim 1, characterized by comprising an annular adaptor flange which is anchored to the annular proximal base and may be anchored around the access opening of the tank.

9. Manipulator, according to claim 1, wherein the bellows element comprises a proximal annular flange connected to the proximal base and a distal annular flange connected to the distal base.

10. Manipulator, according to claim 9, wherein the proximal annular flange has a proximal diameter greater than the distal annular flange.

11. Manipulator, according to claim 10, wherein
the bellows element comprises a proximal part connected to the proximal annular flange and a distal part connected to the distal annular flange;
the proximal part and the distal part of the bellows element are connected to one another by means of a dividing ring.

12. Manipulator, according to claim 11, wherein
the dividing ring comprises a proximal annular section (11a) connected to the proximal part of the bellows element and a distal annular section (11b) connected to the distal part of the bellows element;
the proximal annular section (11a) has a diameter greater than the distal annular section (11b).

13. Manipulator, according to claim 10, wherein the bellows element is at least partially frustoconical.

14. Manipulator, according to any one of claim 10, wherein the dividing ring and the proximal flange of the bellows element are connected to one another by means of a plurality of springs (11c) designed to ensure a minimum separation between the dividing ring in relation to the proximal flange.

15. Manipulator, according to claim 1, wherein the distal base comprises a central opening and the sample-carrying column is connected to a clamping plate mounted on the distal base to seal said central opening.

16. Manipulator, according to claim 1, wherein
each proximal ball joint comprises a proximal spherical bearing arranged on the proximal base and a proximal spherical head element mounted on one of the actuators; each distal ball joint comprises a distal spherical bearing arranged on the distal base and a distal spherical head element mounted on this actuator.

17. Manipulator, according to claim 16, wherein each actuator comprises
an electric motor with a drive shaft connected to a reduction gear, a ball screw coupled proximally to the reduction gear, and a distal fixed nut on which the ball screw rotates;
a hollow, outer moving body with an inner axial passage (15a) in which the fixed nut is immobilized, a distal end (15b) on which the distal spherical head element is mounted and an open proximal end (15c);
a hollow, inner fixed body at least partially inserted into the inner axial passage (15a) of the outer moving body, with a proximal end (16a) on which said proximal spherical head is mounted, a distal end (16b) facing the fixed nut, and an axial cavity (16c) that extends between the proximal end and the distal end of the hollow inner body, and on which the electric motor and the reduction gear are mounted;
and in that the outer moving body is axially slidable over the inner moving body on longitudinal guide rails, between an extended position and a retracted position by action of the ball screw that, when it rotates, moves the fixed nut that pulls the outer moving body.

18.-26. (canceled)
